(19) United States
(12) Patent Application Publication
(10) Pub. No.: US 2020/0137461 A1
(43) Pub. Date: Apr. 30, 2020

(54) AUDIO-VIDEO RESOURCES SHARING DEVICE AND SHARING METHOD THEREOF

(71) Applicant: Shenzhen Zhongjing Electronic Co, Ltd., Shenzhen (CN)

(72) Inventor: Zheng Li, Shenzhen (CN)

(21) Appl. No.: 16/234,841

(22) Filed: Dec. 28, 2018

(30) Foreign Application Priority Data
Oct. 30, 2018 (CN) 201811277757.X

(51) Int. Cl. H04N 21/6437; H04L 29/06; H04N 21/4363; H04N 21/647

(52) U.S. Cl. CPC H04N 21/6437; H04L 65/608; H04N 21/64792; H04N 21/43635; H04L 65/607

(57) ABSTRACT

An audio-video resources sharing device and sharing method thereof, and the device comprises a distributing unit, a converting unit, an encoding unit and a network port; wherein the distributing unit is configured to receive a cable signal, a satellite signal, a terrestrial television signal, and an IPTV set-top box signal, and divide a received signal into multiple output signals, wherein one output signals is transmitted to a television, the remaining output signals are transmitted to the converting unit; the converting unit is configured to receive the output signals and convert the output signals into a MIPI signal; the encoding unit is configured to convert the MIPI signal into a RTMP network signal and send the RTMP network signal to the network port; the network port is configured to transmit the RTMP network signal to a cloud server for being watched by a plurality of mobile terminals.

### CROSS REFERENCE TO RELATED APPLICATION

[I] The present application claims the priority to Chinese application with application No. CN201811277757.X, filed on Oct. 30, 2018. The contents of CN201811277757.X are all hereby incorporated by reference.

### FIELD OF THE INVENTION

The present application relates to an audio-video resources processing device, and more particularly, to an audio-video resources sharing device and sharing method thereof.

### BACKGROUND OF THE INVENTION

With the development of the network technology, more and more network set-top boxes could allow the user to choose to receive corresponding program source, and there are a lot of ways to watch programs, such as TVs, set-top boxes, and mobile phones.

However, these programs could only be searched at positions closing to the network set-top boxes, and once at the outdoor or the network signal is poor, the programs may fail to be watched or may appear to be stuck.

Therefore, it is necessary to design an audio-video resources sharing device, to realize dividing the searched signal from one channel into multiple channels, so as to be used by a television and outdoor mobile terminals, which is convenient and of high practicability.

### SUMMARY OF THE INVENTION

To solve the deficiencies of the prior art, the embodiments of the present application provides an audio-video resources sharing device and sharing method thereof.

In order to realize the above object, the embodiments of the present application adopt the following technical solution: an audio-video resources sharing device, comprising a distributing unit, a converting unit, an encoding unit and a network port; wherein the distributing unit is configured to receive a cable signal, a satellite signal, a terrestrial television signal, and an IPTV set-top box signal, and divide a received signal into multiple output signals, wherein one of the multiple output signals is transmitted to a television, the remaining output signals are transmitted to the converting unit; the converting unit is configured to receive the output signals and convert the output signals into a MIPI signal; the encoding unit is configured to convert the MIPI signal into a RTMP network signal and send the RTMP network signal to the network port; the network port is configured to transmit the RTMP network signal to a cloud server for being watched by a plurality of mobile terminals.

A further technical solution is: the network port is further connected to a router, and the router is configured to transmit the RTMP network signal to the cloud server.

A further technical solution is: the distributing unit comprises a distributor, a main control chip, and a first interface, and the first interface is connected to the distributor, and the distributor is connected to the main control chip, and the main control chip is connected to the converting unit.

A further technical solution is: the converting unit comprises a conversion chip, and the conversion chip is connected to the distributor, and the conversion chip is connected to the encoding unit.

A further technical solution is: the encoding unit comprises an encoder, and the model of the encoder is M5301S.

A further technical solution is: the device further comprises a power supply unit, and the power supply unit comprises a power supply module and a power management module, and the power supply module is connected to the power management module, and the power supply module is respectively connected to the encoding unit, the converting unit, the distributing unit, and the network port.

A further technical solution is: the network port comprises an Ethernet transceiver chip.

A further technical solution is: the device further comprises a control unit, and the control unit is configured to learn a code value of a remote control of an IPTV set-top box, and transmit the code value to control a switching of a signal of the IPTV set-top box.

A further technical solution is: the control unit comprises an infrared chip and an infrared emitting diode, and the infrared chip is connected to the infrared emitting diode, and the infrared emitting diode is connected to the IPTV set-top box.

The embodiments of the present application also provide a sharing method of an audio-video resources sharing device, the method comprises:

a distributing unit receives a cable signal, a satellite signal, a terrestrial television signal, and an IPTV set-top box signal, and divides the received signal into multiple output signals, wherein one of the multiple output signals is transmitted to a television, and the remaining output signals are transmitted to a converting unit;

the converting unit receives the output signals and converts the output signals into a MIPI signal;

an encoding unit converts the MIPI signal into a RTMP network signal and sends the RTMP network signal to a network port;

the network port transmits the RTMP network signal to a cloud server for being watched by a plurality of mobile terminals;

a control unit learns a code value of a remote control of an IPTV set-top box and stores the code value in the encoding unit, and the learned code value of the remote control is transmitted to an infrared receiving window of the IPTV set-top box by the control unit, to control the IPTV set-top box to change channel, search channel and realize a menu operation.

Compared with the prior art, the embodiments of the present application have the following beneficial effect: the embodiments of the present application adopt a distributing unit, a converting unit, an encoding unit and a network port, and uses the distributing unit to divide the acquired signal from one channel into multiple channels, and one channel of the multiple channels is transmitted to the television, and one channel of the multiple channels is transmitted to the converting unit, and after being converted into the MIPI signal by the converting unit and then being converted into the RTMP network signal by the encoding unit, the signal was sent to the network port, and the network port transmits the RTMP network signal to the cloud server for being watched by multiple mobile terminals, thereby realizing dividing the searched signal from one channel into multiple channels, so as to be used by the television and outdoor mobile terminals, which is convenient and of high practicability.

The present application will be further described with reference to the accompanying drawings and the embodiments.

### BRIEF DESCRIPTION OF THE DRAWINGS

In order to more clearly describe the technical solutions of the embodiments of the present application, the drawings used in the description of the embodiments will be briefly described below, and apparently, the drawings described below are some embodiments of the present application, and for persons skilled in the art, other drawings could be obtained according to these drawings without creative efforts.

FIG. 1 is a schematic block diagram of an audio-video resources sharing device provided by an embodiment of the present application;

FIG. 2 is a specific circuit schematic diagram of an distributor U2 provided by an embodiment of the present application;

FIG. 3 is a specific circuit schematic diagram of a main control chip U3 provided by an embodiment of the present application;

FIG. 4 is a specific circuit schematic diagram of a first interface CN1 provided by an embodiment of the present application;

FIG. 5a is part of a specific circuit schematic diagram of a converting unit provided by an embodiment of the present application;

FIG. 5b is another part of the specific circuit schematic diagram of the converting unit provided by the embodiment of the present application;

FIG. 6 is a specific circuit schematic diagram of a USB unit provided by an embodiment of the present application;

FIG. 7 is a specific circuit schematic diagram of an encoding chip UG1P, UG1O, UG1H provided by an embodiment of the present application;

FIG. 8 is a specific circuit schematic diagram of an external memory UG7 provided by an embodiment of the present application;

FIG. 9 is a specific circuit schematic diagram of an encoding chip UG1K provided by an embodiment of the present application;

FIG. 10 is a specific circuit schematic diagram of an encoding chip UG1E and the encoding chip UG1N provided by an embodiment of the present application;

FIG. 11 is a specific circuit schematic diagram of an encoding chip UG1C and the encoding chip UG1D provided by an embodiment of the present application;

FIG. 12 is a specific circuit schematic diagram of an encoding chip UG1Q, UG1J, UG1R, UG1F provided by an embodiment of the present application;

FIG. 13 is a specific circuit schematic diagram of a network port provided by an embodiment of the present application;

FIG. 14 is a specific circuit schematic diagram of a power supply module provided by an embodiment of the present application;

FIG. 15a is part of a specific circuit schematic diagram of a power management module provided by an embodiment of the present application;

FIG. 15b is another part of the specific circuit schematic diagram of the power management module provided by the embodiment of the present application;

FIG. 16 is a specific circuit schematic diagram of a control unit provided by an embodiment of the present application.

### DESCRIPTION OF THE EMBODIMENTS

The technical solutions in the embodiments of the present application will be clearly and completely described below with reference to the accompanying drawings in the embodiments of the present application. It is obvious that the described embodiments are a part of the embodiments of the present application, but not all of the embodiments. All other embodiments obtained by persons skilled in the art based on the embodiments of the present application without creative efforts shall fall into the protection scope of the present application.

It should be understood that the terms “comprising” and “containing”, when used in the specification and the claims, indicate the existence of the described features, integers, steps, operations, elements, and/or components, but do not exclude the existence or addition of one or a plurality of other features, integers, steps, operations, elements, components, and/or collections thereof.

It should also be understood that the terms used in the specification of the present application are only for the purpose of describing a specific embodiment and are not intended to limit the present application. As used in the specification and the appended claims of the present application, the singular forms “a”, “an” and “the” also comprises the plural form, unless the context clearly indicates other situations.

It should be further understood that the terms “and/or” used in the specification and the appended claims of the present application means any combination and all possible combinations of one or a plurality of the associated listed items, and comprises these combinations.

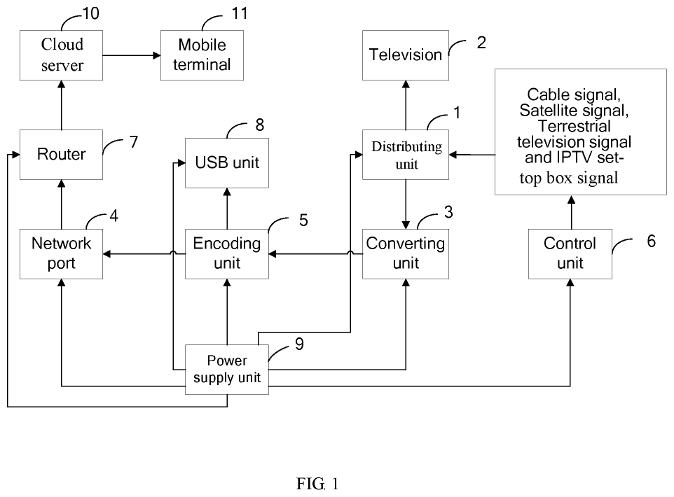

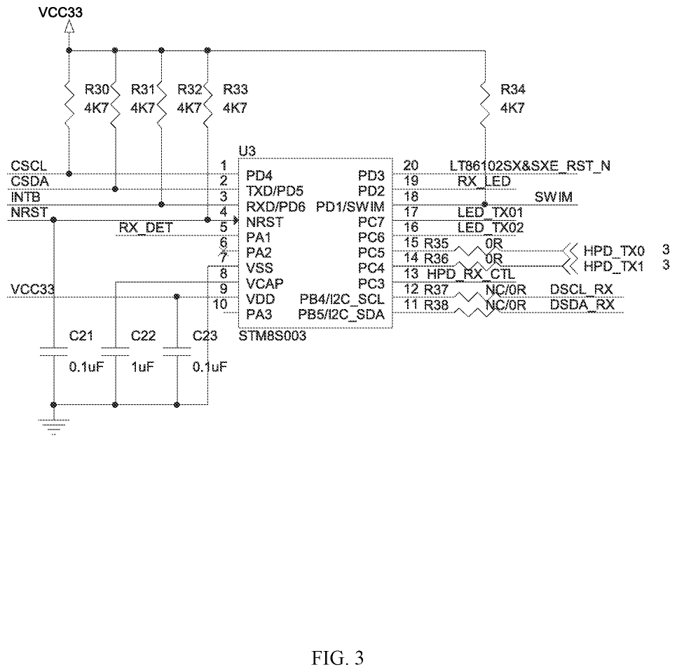

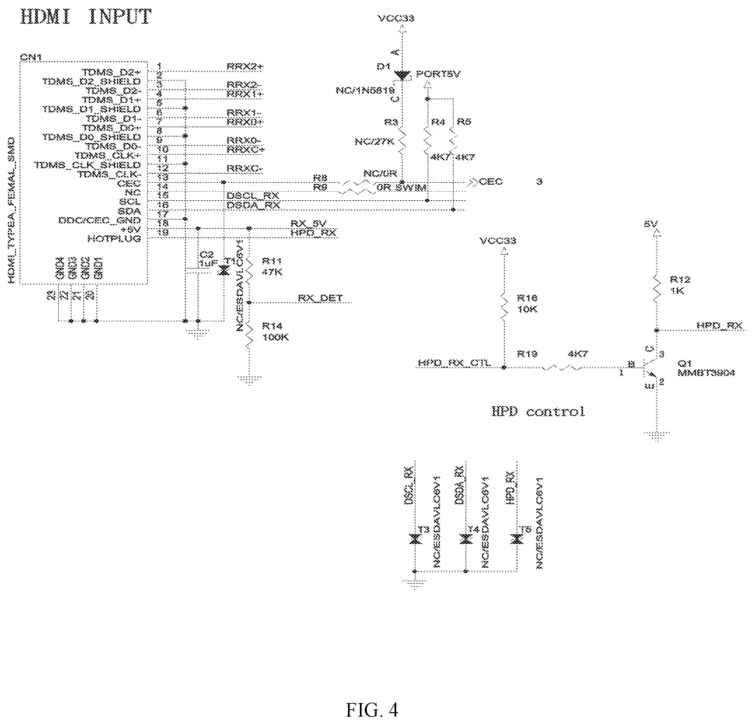

As shown in FIG. 1 to FIG. 16, an audio-video resources sharing device provided in the embodiment could be used for playing a program on a television and playing a program on a mobile terminal 11, to realize dividing the searched signal from one channel into multiple channels, so as to be used by the television and outdoor mobile terminal 11, which is convenient and of high practicability.

Referring to FIG. 1, FIG. 1 is a schematic block diagram of an audio-video resources sharing device provided by an embodiment of the present application; as shown in FIG. 1, the audio-video resources sharing device comprises a distributing unit 1, a converting unit 3, an encoding unit 5 and a network port 4; wherein the distributing unit 1 is configured to receive a cable signal, a satellite signal, a terrestrial television signal, and an IPTV set-top box signal, and divide the received signal into multiple output signals, wherein one of the multiple output signals is transmitted to a television 2, the remaining output signals are transmitted to the converting unit 3; the converting unit 3 is configured to receive the output signals and convert the output signals into MIPI signal; the encoding unit 5 is configured to convert the MIPI signal into RTMP network signal and send the RTMP network signal to the network port 4; the network port 4 is configured to transmit the RTMP network signal to a cloud server 10 for being watched by a plurality of mobile terminals 11. The mobile terminal 11 performs watching by downloading a dedicated APP, and the mobile terminal 11 comprises a smartphone, a tablet, a notebook, and a desktop computer.

In an embodiment, the above network port 4 is also connected to a router 7, and the router 7 is configured to transmit the RTMP network signal to the cloud server 10; the plurality of mobile terminals 11 could download the RTMP network signal from the cloud server 10 and play it on the mobile terminal 11.

The above device further comprises a power supply unit 9 for supplying power to the distributing unit 1, the converting unit 3, the encoding unit 5, and the network port 4.

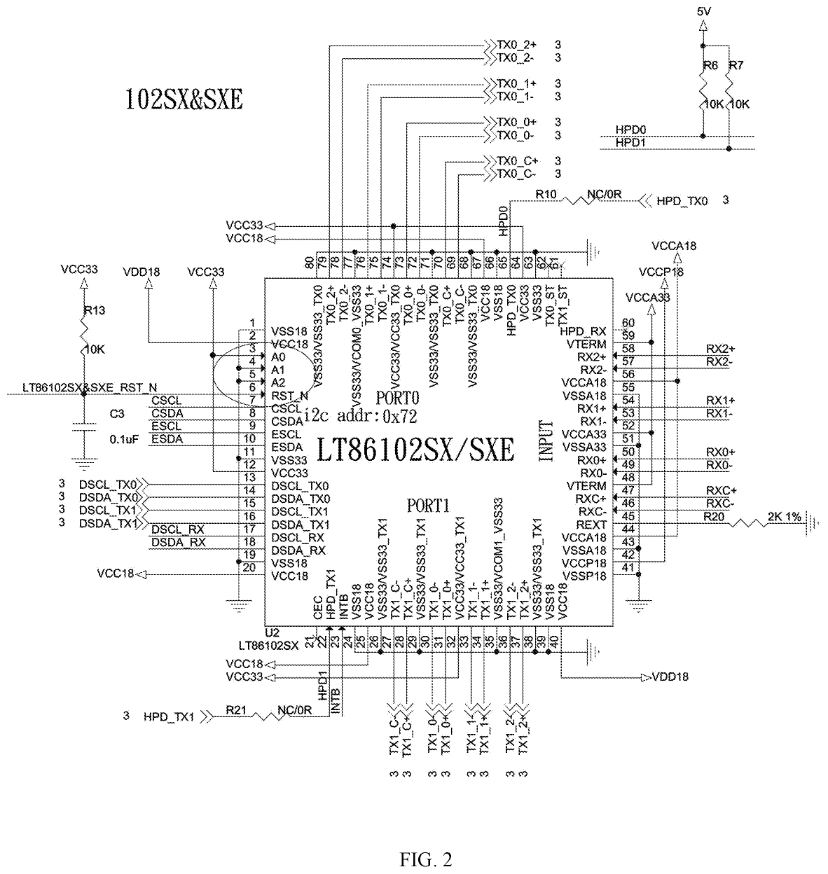

In an embodiment, as shown in FIG. 2 to FIG. 4, the distributing unit 1 comprises a distributor U2, a main control chip U3, and a first interface CN1, and the first interface CN1 is connected to the distributor U2, and the distributor U2 is connected to the main control chip U3, and the main control chip U3 is connected to the converting unit 3. External video signal (such as: cable, satellite, terrestrial TV 2, IPTV TV set-top box, etc.) is input to the distributor U2 through the first interface CN1, and is converted into two outputs by the distributor U2, and one output is transmitted to the television 2, and the other output is transmitted to the converting unit 3 for being watched by the mobile terminal 11.

In the present embodiment, the above first interface CN1 is HDMI interface. The pin of the first interface CN1 is connected to detection resistors R11 and R14, and the detection resistors R11 and R14 are connected to the main control chip U3 for signal detection.

The first interface CN1 is connected to the IPTV set-top box through a HPD control module, and the HPD control module is connected to the main control chip U3, and the HPD control module comprises a transistor Q1, a pull-up resistor R12 and a divider resistor R19, wherein the pull-up resistor R12 and the divider resistor R19 are respectively connected to the transistor Q1, and the transistor Q1 is connected to the main control chip U3, and the main control chip U3 controls the turning-on and turning-off of the transistor Q1 to realize receiving data of the IPTV set-top box.

The first interface CN1 is connected to a pull-up resistor R3 and a zener diode D1 to pull the voltage up to a specified voltage, so that the first interface CN1 could work normally.

The first interface CN1 is further connected to bidirectional zener diodes T3, T4 and T5 to stabilize the data transmission of the first interface CN1.

In the embodiment, the model of the distributor U2 is, but not limited to, LT86102SX/SXE, and the model of the main control chip U3 is, but not limited to, STM8S003.

The acquired signal is divided from one into two by the distributor U2, and one is transmitted to the TV 2, and the other one is transmitted to the main control chip U3, and transmitted to the converting unit 3 by the main control chip U3.

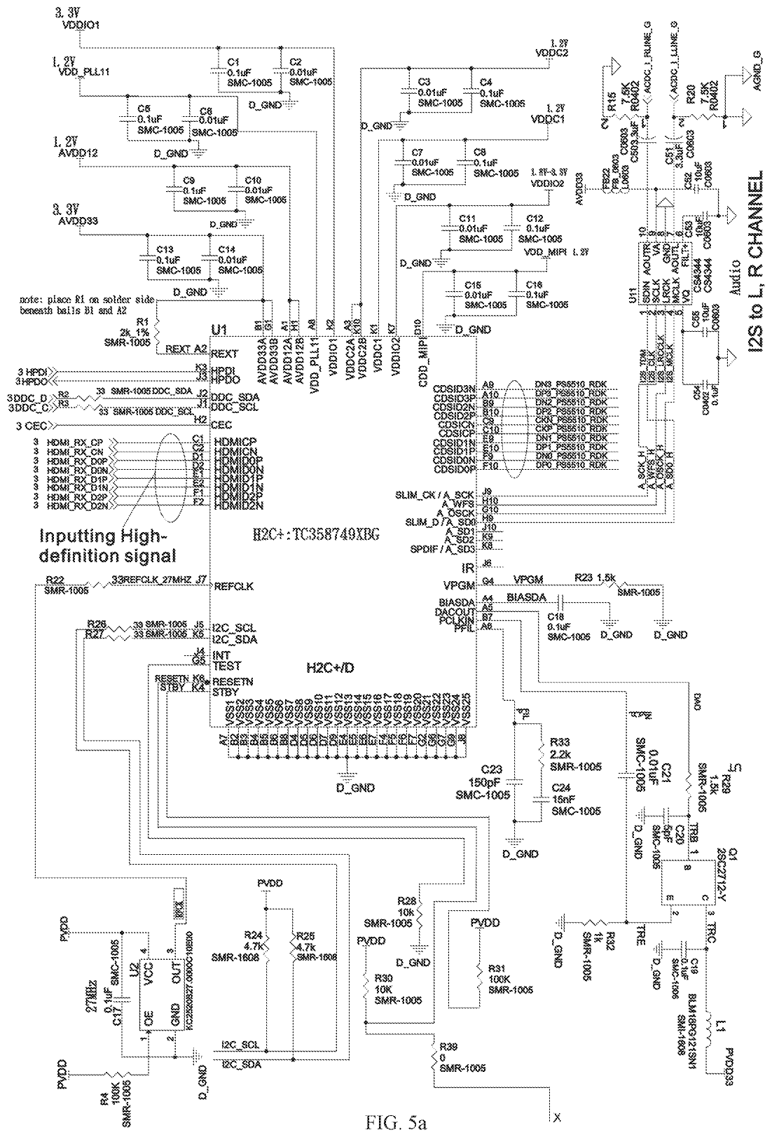

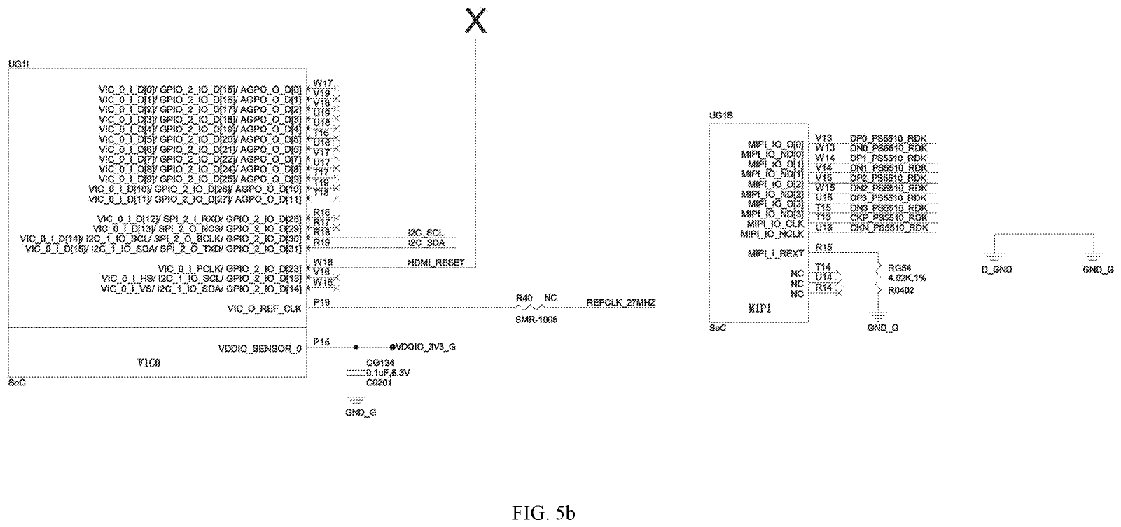

In an embodiment, referring to FIG. 5a and FIG. 5b, the converting unit 3 comprises a conversion chip U1, and the conversion chip U1 is connected to the distributor U2, and the conversion chip U1 is connected to the encoding unit 5.

Specifically, the model of the conversion chip U1 is, but not limited to, TC358749XBG. The REFCLK pin of the conversion chip U1 is connected to the power supply unit 9 through an oscillator U21, and the OE pin and the VCC pin of the oscillator U21 are connected to a capacitor C17 to provide a clock function, and the model of the oscillator U21 is, but not limited to, KC2520B27.0000C10E00.

In addition, the pin of the conversion chip U1 is also connected to a stereo D/A converter U11 which is connected to a microphone and a pickup, and the stereo D/A converter U11 performs D/A conversion to the audio signal and inputs it into the conversion chip U1 for the subsequent encoding processing. In the present embodiment, the model of the stereo D/A converter U11 described above is, but not limited to, CS4344.

In addition, the pin of the stereo D/A converter U11 is also connected to filter capacitors C0603, C51 for filtering and de-noising the audio signal.

In an embodiment, an inductance L1 and a triode Q1 are further connected between the conversion chip U1 and the power supply unit 9, and the inductor L1 is connected to the collector of the transistor Q1, and the base of the transistor Q1 is connected to the conversion chip U1 through a resistor R29, and the emitter of the transistor Q1 is connected to the ground through a resistor R32.

In an embodiment, the encoding unit 5 comprises an encoder, and the model of the encoder is, but not limited to, M5301S. As shown in FIG. 5a and FIG. 5b, the encoder comprises encoding chips UG1I, UG1S, wherein the encoding chip UG1I performs a reset operation under the control of the conversion chip U1, and the encoding chip UG1S is configured to receive the MIPI signal transmitted by the conversion chip U1 for performing conversion operation.

In an embodiment, the device further comprises a USB unit 8, and the USB unit is connected to the encoder.

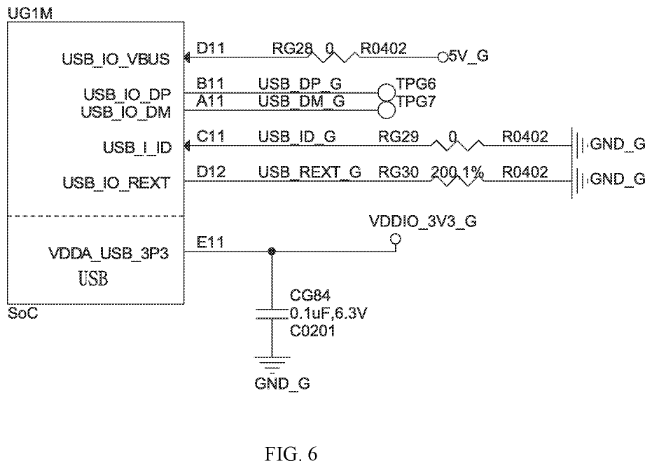

Preferably, the USB unit 8 may be part of an encoding chip, that is, the USB unit 8 is constituted by an encoding chip UG1M comprised in the encoding chip as shown in FIG. 6.

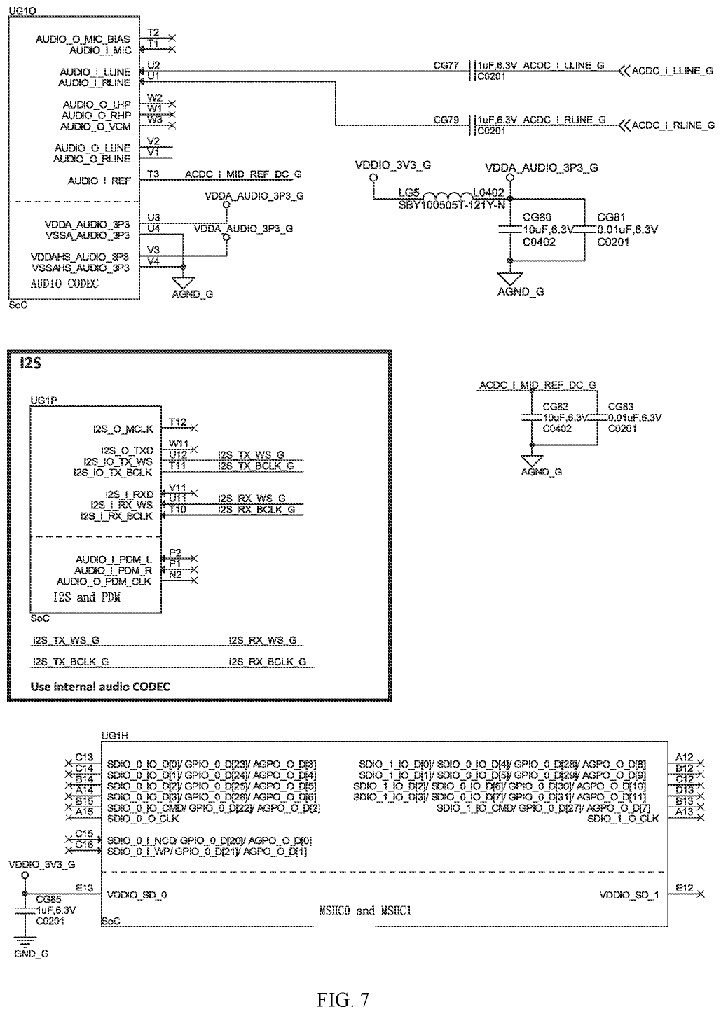

In an embodiment, as shown in FIG. 7, the encoder further comprises encoding chips UG1P, UG1O, UG1H; wherein the encoding chips UG1P, UG1O are configured to receive audio signal, and the encoding chip UG1H is used as a SDIO interface, and the SDIO interface is an interface developed on the basis of the SD memory card interface, and the SDIO interface is compatible with the previous SD memory card, and could be connected to a device with a SDIO interface.

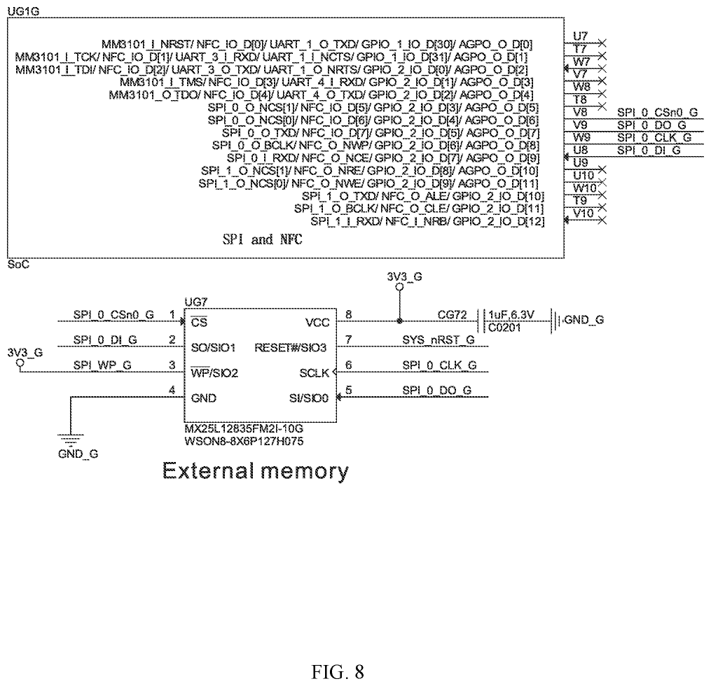

In an embodiment, referring to FIG. 8, the encoding unit 5 further comprises an external memory UG7, and the encoding chip further comprises an encoding chip UG1G, and the encoding chip UG1G is connected to the external memory UG7 for storing audio-video data.

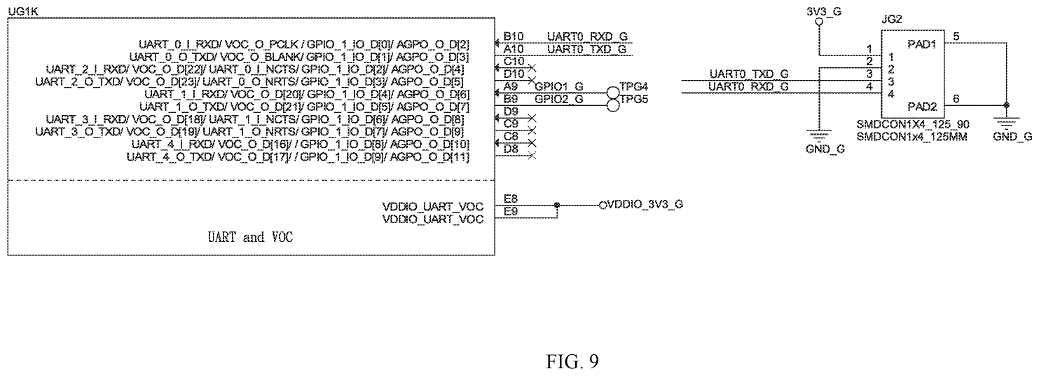

In an embodiment, referring to FIG. 9, the encoder further comprises an encoding chip UG1K, and the encoding chip UG1K is connected to an interface JG2 as a control interface of a UART/GPIO.

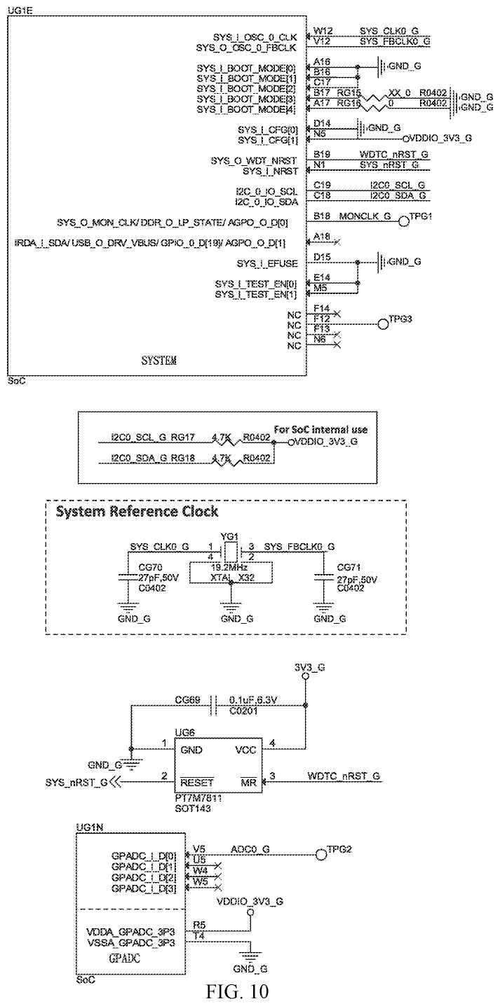

In an embodiment, referring to FIG. 10, the encoder further comprises an encoding chip UG1E, and the encoding chip UG1E is connected to an oscillator YG1 to provide a clock function.

In addition, the pin of the encoding chip UG1E is connected to a reset chip UG6 for a resetting of the encoder. Specifically, the model of the reset chip UG6 is, but not limited to, PT7M7811.

Further, the encoder further comprises an encoding chip UG1N, and the encoding chip UG1N is configured to provide an analog-digital conversion function.

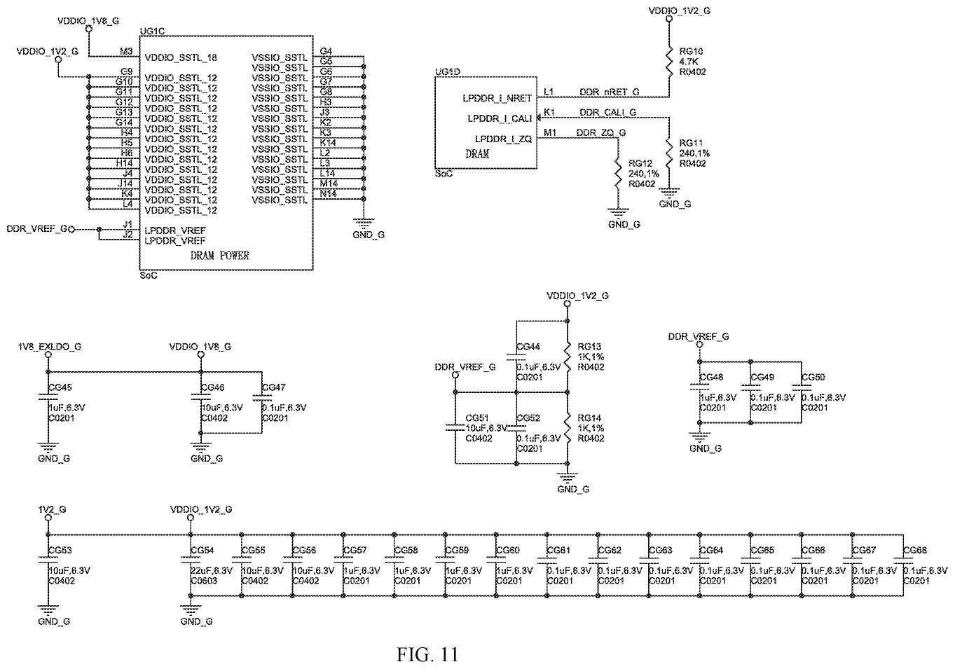

In an embodiment, referring to FIG. 11, the encoder further comprises encoding chips UG1C, UG1D, and the encoding chips UG1C and UG1D are used as internal memory.

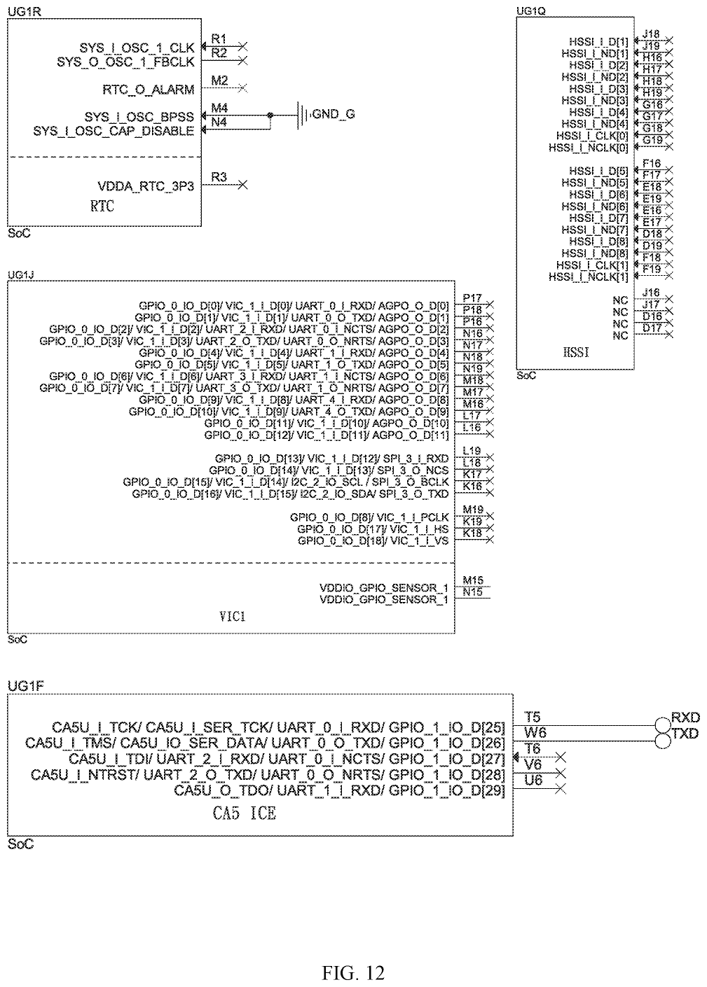

In an embodiment, referring to FIG. 12, the encoder comprises encoding chips UG1Q, UG1J, UG1R, and UG1F. The encoding chips UG1Q and UG1J are used as a MIPI input interface, and the encoding chip UG1R is used as the RTC.

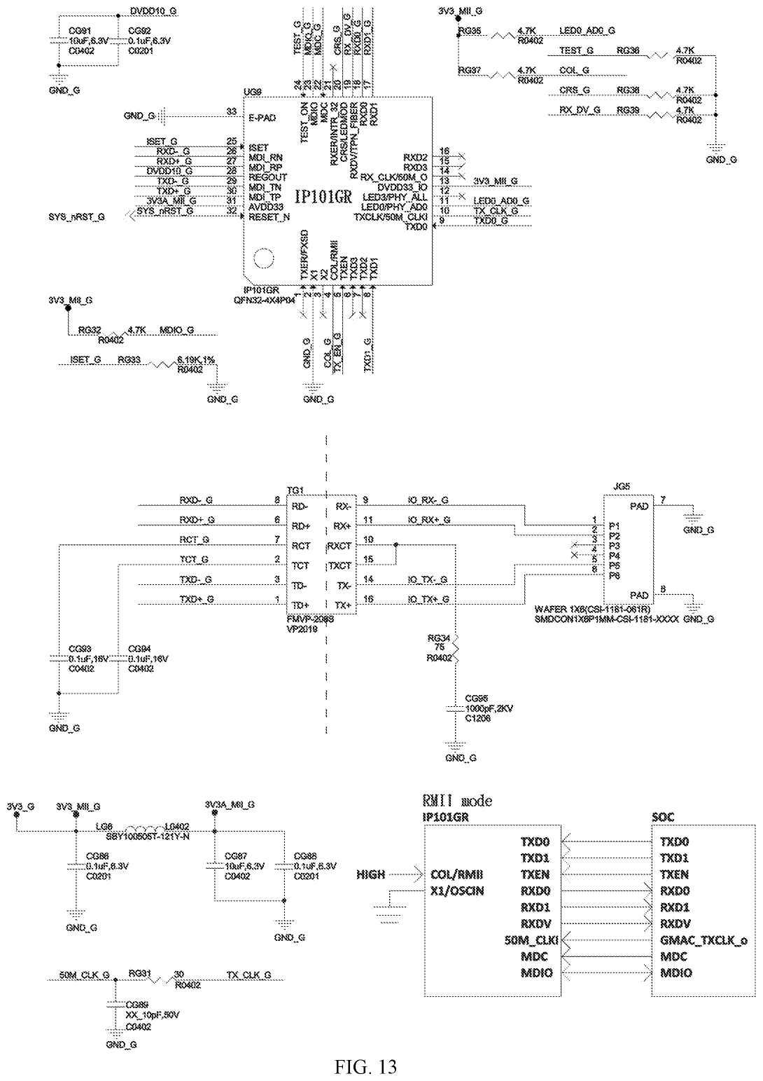

In an embodiment, referring to FIG. 13, the network port 4 comprises an Ethernet transceiver chip UG9, and the model of the Ethernet transceiver chip UG9 is, but not limited to, IP101GR. In addition, the encoder further comprises an encoding chip UG1L, and the encoding chip UG1L is connected to the Ethernet transceiver chip UG9 for controlling the transmitting and receiving of the network port 4, and the pin of the Ethernet transceiver chip UG9 is also connected to a network transformer TG1, and the network transformer TG1 is connected to an interface JG5, and the model of the network transformer TG1 is, but not limited to, VP2019.

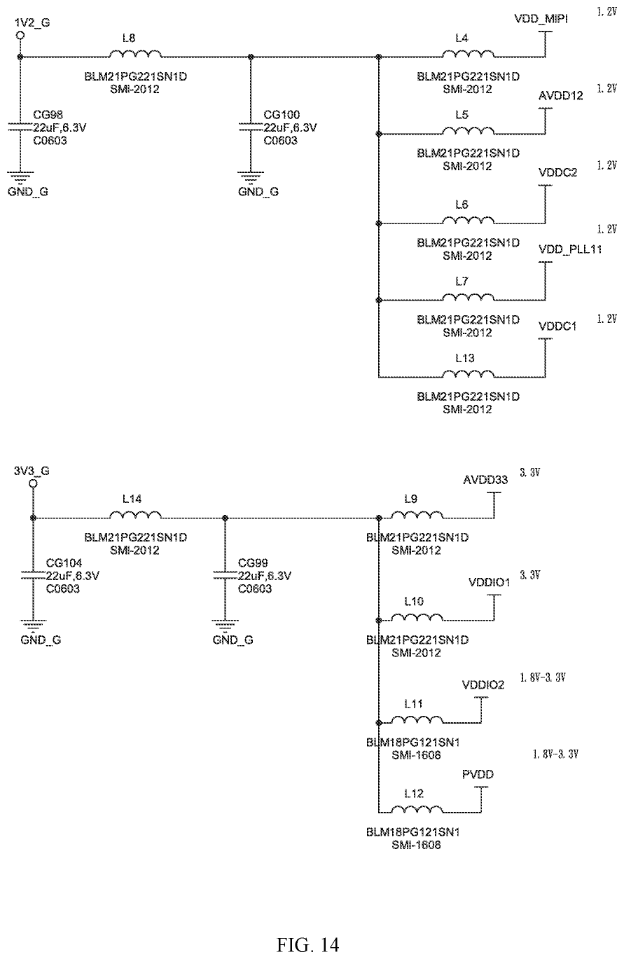

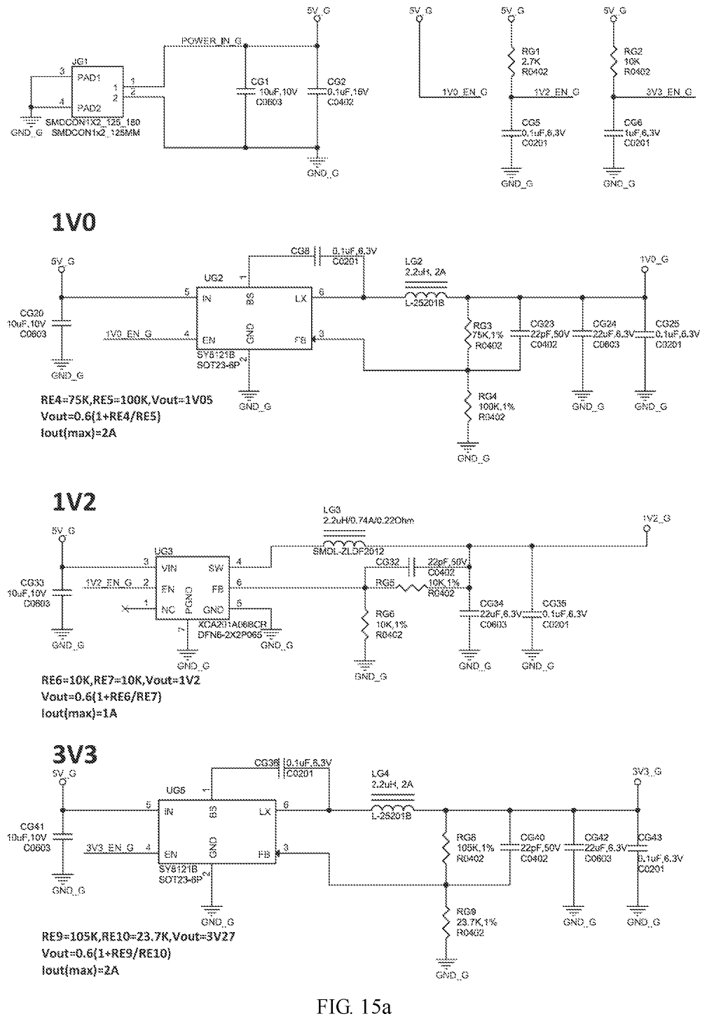

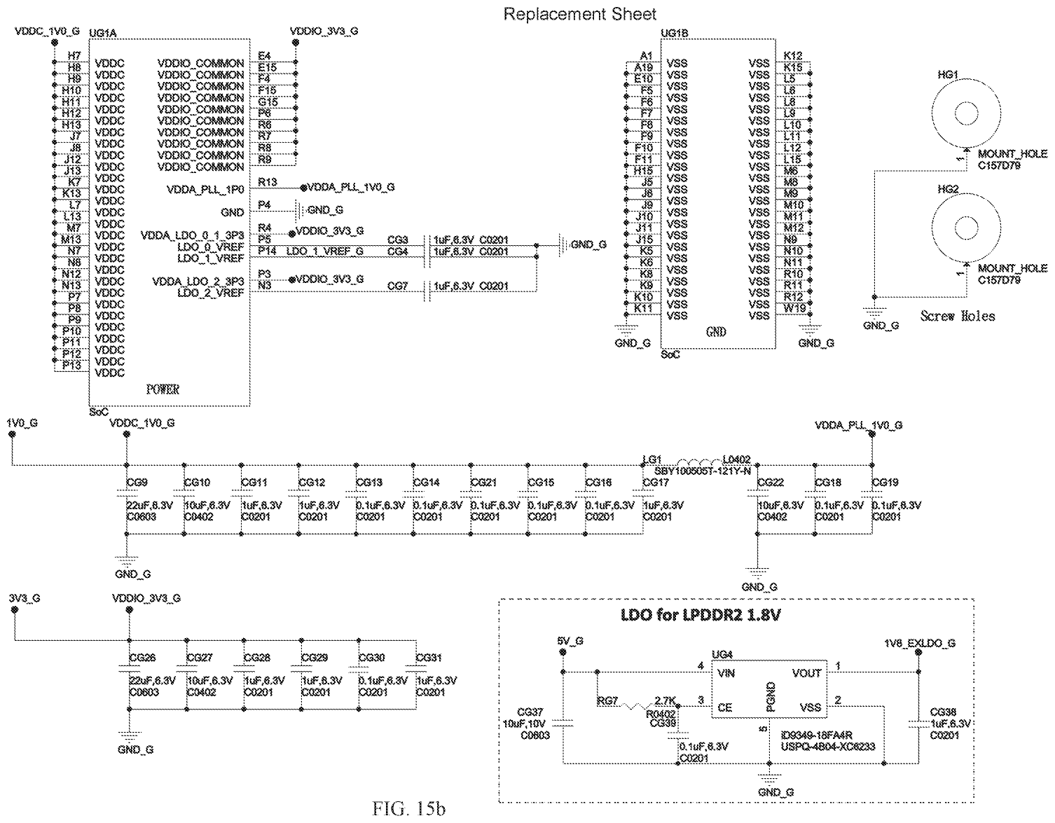

In an embodiment, referring to FIG. 14 and FIG. 15a and FIG. 15b, the power supply unit 9 comprises a power supply module and a power management module, and the power supply module is connected to the power management module, and the power supply module is respectively connected to the encoding unit 5, the converting unit 3, the distributing unit 1, and the network port 4.

Referring to FIG. 15a and FIG. 15b, the power management module comprises a power interface JG1, a power management chip UG2, a power management chip UG3, a power management chip UG4, and a power management chip UG5, wherein the power interface JG1 is connected to an external power supply of 5V, and the power interface JG1 is respectively connected to the power management chip UG2, the power management chip UG3, the power management chip UG4 and the power management chip UG5, wherein the power management chip UG2 converts a voltage of 5V to a voltage of 1V, and the power management chip UG3 converts a voltage of 5V to a voltage of 1.2V, and the power management chip UG4 converts a voltage of 5V to a voltage of 1.8V, and the power management chip UG5 converts the voltage of 5V to a voltage of 3.3V.

In addition, the encoder further comprises encoding chips UG1A, UG1B, and the encoding chip UG1A, UG1B are connected to the power management chip UG5, to realize the effect of supplying power to the encoder.

Specifically, the model of the power management chip UG2 is, but not limited to, SY8121B.

The model of the power management chip UG3 is, but not limited to, XCA201A06BCR.

The model of the power management chip UG4 is, but not limited to, ID9349-18FA4R.

The model of the power management chip UG5 is, but not limited to, SY8121B.

Referring to FIG. 14, the power management chip UG3 and the power management chip UG5 are respectively connected to the power supply module, and the power supply module comprises inductors L8, L4, L5, L6, L7, L13, L14, L9, L10, L11, L12; wherein the power management chip UG3 is connected to the inductor L8, and the power management chip UG5 is connected to the inductor L14, and the inductor L8 is respectively connected to the inductors L4, L5, L6, L7, and L13, and the inductor L14 is respectively connected to the inductors L9, L10, L11, and L12.

Wherein, the conversion chip U1 is connected to any one of the inductors L4, L5, L6, L7, and L13, and the main control chip U3 is connected to any one of the inductors L9, L10, L11, and L12; the distributor U2 is connected to the power interface JG1; the Ethernet transceiver chip UG9 is connected to any one of the inductors L9, L10, L11, and L12.

In an embodiment, the device further comprises a control unit 6, and the control unit 6 is configured to learn a code value of a remote control of the IPTV set-top box, and transmit the code value to control the switching of a signal of the IPTV set-top box.

The control unit 6 is used on the shared IPTV set-top box to learn the code value of the remote control of the IPTV set-top box in a user's home and store it in the encoder. The learned code value of the remote control is transmitted to an infrared receiving window of the IPTV set-top box through an infrared chip U5 and an infrared emitting diode LED5, to realize the functions of controlling the IPTV set-top box to change channel, search channel and the menu function.

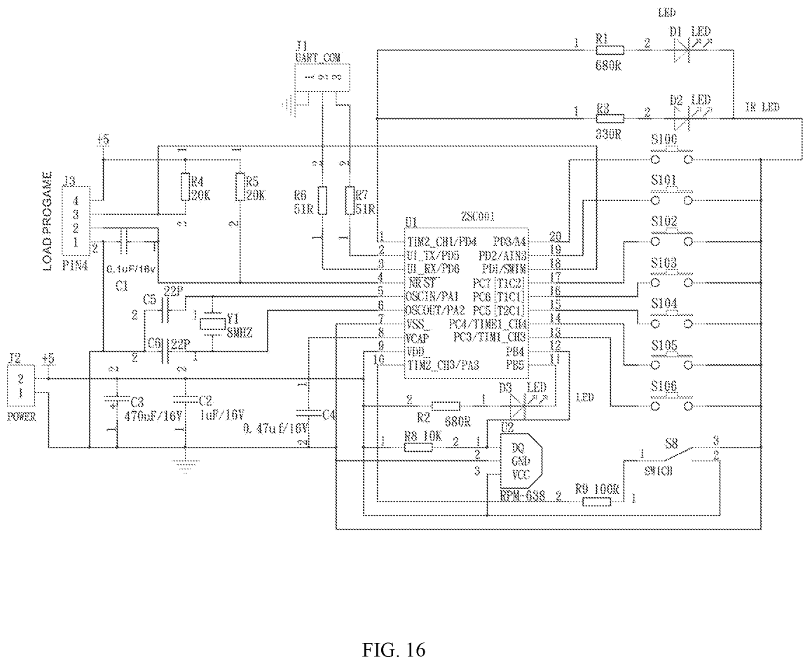

In an embodiment, as shown in FIG. 16, the control unit comprises the infrared chip U5 and the infrared emitting diode LED5, and the infrared chip U5 is connected to the infrared emitting diode LED5, and the infrared emitting diode LED5 is connected to the IPTV set-top box.

The model of the infrared chip U5 is ZSC001, and the infrared chip U5 is also connected to a plurality of buttons S100, S101, S102, S103, S104, S105, S106; the infrared chip U5 is also connected to a selection switch S8, and the infrared chip U5 is connected to the power supply unit 9 through an interface J4, and filter capacitors C3, C2, and C4 are connected between the interface J4 and the infrared chip U5; In addition, the infrared chip U5 is also connected to a programming pin J3 and a serial interface J1, and the infrared chip U5 is also connected to an infrared remote connector U6, and the model of the infrared remote connector U6 is RPM-638; the infrared chip U5 is also connected to an indicator LED4 for remote control reminder.

The infrared chip U5 could learn the code value of the remote control of the external video signal (such as: cable, satellite, terrestrial TV 2, IPTV TV set-top box, etc.), thereby realizing using a handheld device to control the IPTV set-top box.

The audio-video resources sharing device adopts the distributing unit 1, the converting unit 3, the encoding unit 5 and a network port 4, and uses the distributing unit 1 to divide the acquired signal from one channel into multiple channels, and one channel of the multiple channels is transmitted to the television 2, and one channel of the multiple channels is transmitted to the converting unit 3, and after being converted into the MIPI signal by the converting unit 3 and then being converted into the RTMP network signal by the encoding unit 5, the signal was sent to the network port 4, and the network port 4 transmits the RTMP network signal to the cloud server 10 for being watched by multiple mobile terminals 11, thereby realizing dividing the searched signal from one channel into multiple channels, so as to be used by the television 2 and outdoor mobile terminals 11, which is convenient and of high practicability.

In an embodiment, a sharing method of an audio and video resources sharing device is also provided, the method comprising:

A distributing unit 1 receives a cable signal, a satellite signal, a terrestrial television signal, and an IPTV set-top box signal, and divides the received signal into multiple output signals, wherein one of the multiple output signals is transmitted to a television 2, and the remaining output signals are transmitted to a converting unit 3;

The converting unit 3 receives the output signals and converts the output signals into a MIPI signal;

An encoding unit 5 converts the MIPI signal into a RTMP network signal and sends the RTMP network signal to a network port 4;

The network port 4 transmits the RTMP network signal to a cloud server 10 for being watched by a plurality of mobile terminals 11.

A control unit 6 learns a code value of a remote control of an IPTV set-top box in a user's home and stores it in the encoding unit 5, and the learned code value of the remote control is transmitted to an infrared receiving window of the IPTV set-top box by the control unit 6, to control the IPTV set-top box to change channel, search channel and the menu operation.

Specifically, the audio-video signal of the IPTV set-top box is connected to the input of the encoding unit 5 through the AV output or the HDMI output; the audio-video signal is converted into a network live stream by the encoding unit and then is transmitted to the cloud server 10 through the network port 4 or a WIFI connection router 7.

After downloading and installing the dedicated application program and registering a username and password, the mobile terminal 11 such as a computer or a mobile phone receives the network live stream allocated by the cloud server 10, and then watches the live program of the television 2 online after decoding the audio and video, and the mobile terminal 11 could control an encoder through the cloud server 10 through the application program, and transmits the learned code value of the remote control to the infrared receiving window of the IPTV set-top box in the home through the infrared emitting diode LED5 of the control unit 6, thereby realizing the functions of controlling the IPTV set-top box to change channel, search channel and the menu function. Users share and exchange usernames and passwords with each other on the cloud server 10 through the application program, thereby realizing sharing live programs of the IPTV set-top box television 2 of different families.

The technical content of the present application is further described by way of the above embodiments to facilitate a reader to easily understand, but it does not indicate that the embodiments of the present application is limited thereto, and any technology extension or re-creation according to the present application falls into the protection scope of the present application. The protection scope of the present application is subject to the claims.

What is claimed is:

1. An audio-video resources sharing device, comprising a distributing unit, a converting unit, an encoding unit and a network port; wherein the distributing unit is configured to receive a cable signal, a satellite signal, a terrestrial television signal, and an IPTV set-top box signal, and divide a received signal into multiple output signals, wherein one of the multiple output signals is transmitted to a television, the remaining output signals are transmitted to the converting unit; the converting unit is configured to receive the output signals and convert the output signals into a MIPI signal; the encoding unit is configured to convert the MIPI signal into a RTMP network signal and send the RTMP network signal to the network port; the network port is configured to transmit the RTMP network signal to a cloud server for being watched by a plurality of mobile terminals.

2. The audio-video resources sharing device according to claim 1, wherein the network port is further connected to a router, and the router is configured to transmit the RTMP network signal to the cloud server.

3. The audio-video resources sharing device according to claim 2, wherein the distributing unit comprises a distributor, a main control chip, and a first interface, and the first interface is connected to the distributor, and the distributor is connected to the main control chip, and the main control chip is connected to the converting unit.

4. The audio-video resources sharing device according to claim 3, wherein the converting unit comprises a conversion chip, and the conversion chip is connected to the distributor, and the conversion chip is connected to the encoding unit.

5. The audio-video resources sharing device according to claim 4, wherein the encoding unit comprises an encoder, and the model of the encoder is M5301S.

6. The audio-video resources sharing device according to claim 5, wherein the device further comprises a power supply unit, and the power supply unit comprises a power supply module and a power management module, and the power supply module is connected to the power management module, and the power supply module is respectively connected to the encoding unit, the converting unit, the distributing unit, and the network port.

7. The audio-video resources sharing device according to claim 1, wherein the network port comprises an Ethernet transceiver chip.

8. The audio-video resources sharing device according to claim 7, wherein the device further comprises a control unit, and the control unit is configured to learn a code value of a remote control of an IPTV set-top box, and transmit the code value to control a switching of a signal of the IPTV set-top box.

9. The audio-video resources sharing device according to claim 8, wherein the control unit comprises an infrared chip and an infrared emitting diode, and the infrared chip is connected to the infrared emitting diode, and the infrared emitting diode is connected to the IPTV set-top box.

10. A sharing method of an audio-video resources sharing device, wherein the method comprises:
a distributing unit receives a cable signal, a satellite signal, a terrestrial television signal, and an IPTV set-top box signal, and divides the received signal into multiple output signals, wherein one of the multiple output signals is transmitted to a television, and the remaining output signals are transmitted to a converting unit;
the converting unit receives the output signals and converts the output signals into a MIPI signal;
an encoding unit converts the MIPI signal into a RTMP network signal and sends the RTMP network signal to a network port;
the network port transmits the RTMP network signal to a cloud server for being watched by a plurality of mobile terminals;
a control unit learns a code value of a remote control of an IPTV set-top box and stores the code value in the encoding unit, and the learned code value of the remote control is transmitted to an infrared receiving window of the IPTV set-top box by the control unit, to control the IPTV set-top box to change channel, search channel and realize a menu operation.
